(19) United States
(12) Patent Application Publication
(10) Pub. No.: US 2024/0162518 A1
(43) Pub. Date: May 16, 2024

(54) POSITIONING HIGH AND LOW ENERGY DENSITY CELLS TO REDUCE CELL BARRIER THICKNESS FOR ENHANCED THERMAL STABILITY

(71) Applicant: GM GLOBAL TECHNOLOGY OPERATIONS LLC, Detroit, MI (US)

(72) Inventor: Anil Yadav, Troy, MI (US)

(73) Assignee: GM GLOBAL TECHNOLOGY OPERATIONS LLC, Detroit, MI (US)

(21) Appl. No.: 17/986,168

(22) Filed: Nov. 14, 2022

(51) Int. Cl. H01M 10/613; H01M 10/625; H01M 10/658

(52) U.S. Cl. CPC H01M 10/613; H01M 10/625; H01M 10/658; H01M 2220/20

(57) ABSTRACT

In some aspects, a battery module includes a plurality of high energy density-based cells sandwiched between low energy density-based cells provides for a relatively thinner cell barrier between groups of cells, which reduces space required for mitigation solution for thermal runaway propagation (TRP) while maintaining a relatively high range of miles in an electric vehicle per individual charge. In some embodiments, the module includes bus bar and tab configurations on the front and rear portions which enables an efficient connection of components using the above-referenced combination of high and low energy density-based cells for optimal performance.

### INTRODUCTION

Electrochemical battery packs are used in a host of battery electric systems. Aboard an electric vehicle in particular, a high-energy propulsion battery pack is arranged on a direct current (DC) voltage bus, with the propulsion battery pack having an application-suitable number of cylindrical, prismatic, or pouch-style electrochemical battery cells. The DC voltage bus ultimately powers one or more electric traction motors and associated power electronic components during battery discharging modes.

Propulsion battery packs for use with electric vehicles and other battery electric systems typically utilize a lithium-based or nickel-based battery chemistry. In lithium-ion battery cells, for instance, the movement of electrons and lithium ions produces electricity for use in powering the above-noted electric traction motor(s). Charging and discharging of the battery cells is accompanied by a discharge of heat. The generated heat in turn must be dissipated from the battery cells, e.g., via circulation of battery coolant, cooling plates, or cooling fins. Under rare conditions, battery cell damage, age, or degradation could lead to the generation of heat in a battery cell or battery pack at a rate exceeding an existing cooling capability. Such a condition is referred to both herein and in the art as thermal runaway propagation (TRP). Cell barrier thickness is a function of maximum temperature of the battery cells during TRP. During TRP, high energy density cells can reach up to 1100 degrees Celsius or higher.

Current module assemblies either use high energy density cells, which use high cost TRP mitigation solutions, or low energy density cells, which only use low cost TRP mitigation solutions, but result in a lower vehicle range.

### SUMMARY

An aspect of the present disclosure includes a battery module. The battery module includes a plurality of groups. Each group includes one or more high energy density-based cells disposed on each side between one or more low energy density-based cells. The module further includes a cell barrier disposed between each of the plurality of groups. A thickness of the cell barrier is reduced based at least in part on an increased onset temperature, relative to another module using an identical number of total cells including only high energy density-based cells, of a thermal runaway propagation (TRP) condition occurring in one or more of the plurality of groups. Because the onset temperature of TRP is higher than if only high energy density-based cells are used in the module, the cell barrier thickness may be lower, and the thermal mitigation solution may be simpler and less expensive.

In a further embodiment, each group in the module may include at least four cells. The one or more high energy density-based cells includes two adjacent cells. The one or more low energy density-based cells includes two cells between which the two adjacent cells are disposed. The module may further include a first bus bar on a front of the module and extending across an upper part of a first set of two adjacent groups. The first bus bar is coupled via two first tabs to two respective low energy density-based cells in a first group of the two adjacent groups. The first bus bar is further coupled via two second tabs to two respective low energy density-based cells in a second group of the two adjacent groups.

In another embodiment, the module further includes a second bus bar on the front of the module and extending across a lower part of a second set of two adjacent groups. The two adjacent groups may include one group from the first set. The second bus bar is coupled via two third tabs to two respective high energy density-based cells in the one group from the first set. The second bus bar is also coupled via two fourth tabs to two respective high energy density-based cells in a remaining group from the second set of two adjacent groups.

In still another embodiment, the module includes a plurality of third bus bars on a rear of the module. Each third bus bar extends across an upper portion and a lower portion of each respective one of at least two adjacent groups. Each of the plurality of third bus bars is coupled to two low energy density-based cells via two respective fifth tabs across the upper portion. Each of the plurality of third bus bars is further coupled to two high energy-density-based cells via two respective sixth tabs across the lower portion.

In yet another aspect of the disclosure, a battery module includes a plurality of groups. The plurality of groups includes at least two high energy density-based cells disposed between one low energy density-based cell on each side. The module further includes a cell barrier disposed between each of the plurality of groups. A thickness of the cell barrier is reduced based at least in part on an increased onset temperature, relative to another module using an identical number of total cells including only high energy density-based cells, of a thermal runaway propagation (TRP) condition occurring in one or more of the plurality of groups. The module further includes a first bus bar on a front of the module. The first bus bar extends across an upper part of a first of two adjacent groups. The first bus bar is further coupled via two first tabs to two respective low energy density-based cells in a first group of the two adjacent groups and via two second tabs to two respective low energy density-based cells in a second group of the two adjacent groups.

In still another aspect of the disclosure, a battery module includes a plurality of groups, each group including a plurality of high energy density-based cells disposed on each side between at least one low energy density-based cell. The module further includes a cell barrier arranged between each of the plurality of groups, a thickness of the cell barrier being reduced based at least in part on an increased onset temperature, relative to another module using an identical number of total cells including only high energy density-based cells, of a thermal runaway propagation (TRP) condition occurring in one or more of the plurality of groups.

In various aspects, the high energy density-based cell includes one of a nickel cobalt manganese (NCM) cell or a nickel cobalt manganese aluminum (NCMA) cell. A module configuration is a 2P12S configuration including four groups per cell or six groups per cell in other embodiments. A module energy output according to certain aspects is between 6 and 12 Kilowatt Hours (kWh).

The above features and advantages, and other features and attendant advantages of this disclosure, will be readily apparent from the following detailed description of illustrative examples and modes for carrying out the present disclosure when taken in connection with the accompanying drawings and the appended claims. Moreover, this disclosure expressly includes combinations and sub-combinations of the elements and features presented above and below.

### BRIEF DESCRIPTION OF THE DRAWINGS

The accompanying drawings, which are incorporated into and constitute a part of this specification, illustrate implementations of the disclosure and together with the description, serve to explain the principles of the disclosure.

FIG. 1 is an exemplary electrified powertrain system equipped with a battery pack having cell vents equipped with sacrificial vent caps in accordance with the disclosure.

FIG. 2A is an exemplary front cross-sectional view of a module in a 2P12S (6:1) configuration using high energy density cells.

FIG. 2B is an exemplary front cross-sectional view of a module in a 2P12S (6:1) configuration using low energy density cells.

FIG. 3 is an exemplary front cross-sectional view of two groups of a module in a (4:1) configuration and separated by a cell barrier according to an aspect of the disclosure.

FIG. 4A is an exemplary front cross-sectional view of a module in a 2P12S (6:1) configuration which combines cells for increased thermal stability according to example embodiments.

FIG. 4B is an exemplary front cross-sectional view of a module in a 2P12S (4:1) configuration which combines cells for increased thermal stability according to example embodiments.

FIG. 5 is an exemplary front cross-sectional view of a module in a 2P12S (4:1) configuration with a bus bar and tabs configuration according to example embodiments.

FIG. 6 is an exemplary back cross-sectional view of the example module of FIG. 5 with bus bars and tabs in accordance with an aspect of the disclosure.

FIG. 7 is an exemplary side cross-sectional view of a low energy density-based battery cell with the tabs arranged near the top of the cell.

FIG. 8 is an exemplary side cross-sectional view of a high energy density-based battery cell with the tabs arranged near the bottom of the cell.

The appended drawings are not necessarily to scale and may present a somewhat simplified representation of various preferred features of the present disclosure as disclosed herein, including, for example, specific dimensions, orientations, locations, and shapes. Details associated with such features will be determined in part by the particular intended application and use environment.

### DETAILED DESCRIPTION

The present disclosure is susceptible of embodiment in many different forms. Representative examples of the disclosure are shown in the drawings and described herein in detail as non-limiting examples of the disclosed principles. To that end, elements and limitations described in the Abstract, Introduction, Summary, and Detailed Description sections, but not explicitly set forth in the claims, should not be incorporated into the claims, singly or collectively, by implication, inference, or otherwise.

For purposes of the present description, unless specifically disclaimed, use of the singular includes the plural and vice versa, the terms “and” and “or” shall be both conjunctive and disjunctive, and the words “including”, “containing”, “comprising”, “having”, and the like shall mean “including without limitation”. Moreover, words of approximation such as “about”, “almost”, “substantially”, “generally”, “approximately”, etc., may be used herein in the sense of “at, near, or nearly at”, or “within 0-5% of”, or “within acceptable manufacturing tolerances”, or logical combinations thereof. As used herein, a component that is “configured to” perform a specified function is capable of performing the specified function without alteration, rather than merely having potential to perform the specified function after further modification. In other words, the described hardware, when expressly configured to perform the specified function, is specifically selected, created, implemented, utilized, programmed, and/or designed for the purpose of performing the specified function.

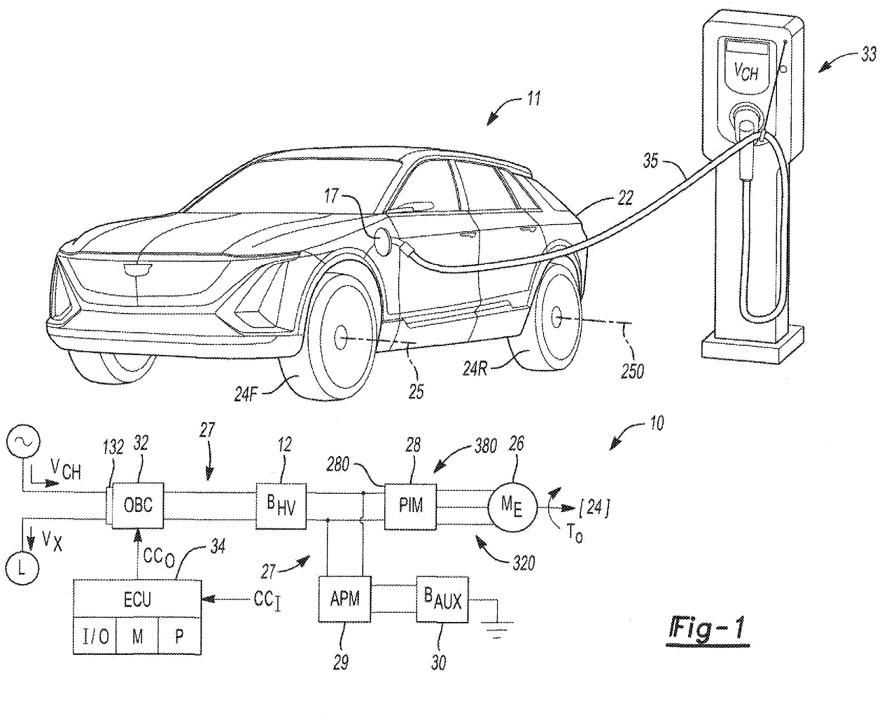

Referring to the drawings, wherein like reference numbers refer to like features throughout the several views, FIG. 1 depicts an electrified powertrain system 10 having a high-voltage battery pack (BHV) 12. In a non-limiting example, the battery pack 12 may be embodied as a high-capacity battery having a voltage capability of about 400-800 volts or more, with the actual voltage capability of the battery pack 12 provided based on a desired operating range, gross weight, and power rating of a load connected to the battery pack 12. In a possible construction, the battery pack 12 may be a propulsion battery pack generally composed of an array of lithium-ion or lithium-ion polymer rechargeable electrochemical battery cells. The present teachings may also be applied to cylindrical battery cells, prismatic battery cells, and possibly to pouch-style battery cells in some configurations, among other possible implementations.

Referring again to FIG. 1, in a representative use case the electrified powertrain system 10 may be used as part of a motor vehicle 11 or another mobile system. As shown, the motor vehicle 11 may be embodied as a battery electric vehicle, with the present teachings also being extendable to plug-in hybrid electric vehicles. Alternatively, the electrified powertrain system 10 may be used as part of another mobile system such as but not limited to a rail vehicle, aircraft, marine vessel, robot, farm equipment, etc. Likewise, the electrified powertrain system 10 may be stationary, such as in the case of a powerplant, hoist, drive belt, or conveyor system. Therefore, the electrified powertrain system 10 in the representative vehicular embodiment of FIG. 1 is intended to be illustrative of the present teachings and not limiting thereof.

The motor vehicle 11 shown in FIG. 1 includes a vehicle body 22 and road wheels 24F and 24R, with “F” and “R” indicating the respective front and rear positions. The road wheels 24F and 24R rotate about respective axes 25 and 250, with the road wheels 24F, the road wheels 24R, or both being powered by output torque (arrow To) from a rotary electric machine (ME) 26 of the electrified powertrain system 10 as indicated by arrow [24]. The road wheels 24F and 24R thus represent a mechanical load in this embodiment, with other possible mechanical loads being possible in different host systems. To that end, the electrified powertrain system 10 includes a power inverter module (PIM) 28 and the high-voltage battery pack 12, e.g., a multi-cell lithium-ion propulsion battery or a battery having another application-suitable chemistry, both of which are arranged on a high-voltage DC bus 27. As appreciated in the art, the PIM 28 includes a DC side 280 and an alternating current (AC) side 380, with the latter being connected to individual phase windings (not shown) of the rotary electric machine (ME) 26 when the rotary electric machine (ME) 26 is configured as a polyphase rotary electric machine in the form of a propulsion or traction motor as shown.

The battery pack 12 of FIG. 1 in turn is connected to the DC side 280 of the PIM 28, such that a battery voltage from the battery pack 12 is provided to the PIM 28 during propulsion modes of the motor vehicle 11. The PIM 28, or more precisely a set of semiconductor switches (not shown) residing therein, are controlled via pulse width modulation, pulse density modulation, or other suitable switching control techniques to invert a DC input voltage on the DC bus 27 into an AC output voltage suitable for energizing a high-voltage AC bus 320. High-speed switching of the resident semiconductor switches of the PIM 28 thus ultimately energizes the rotary electric machine (ME) 26 to thereby cause the rotary electric machine (ME) 26 to deliver the output torque (arrow To) as a motor drive torque to one or more of the road wheels 24F and/or 24R in the illustrated embodiment of FIG. 1, or to another coupled mechanical load in other implementations.

Electrical components of the electrified powertrain system 10 may also include an accessory power module (APM) 29 and an auxiliary battery (BAUx) 30. The APM 29 is configured as a DC-DC converter that is connected to the DC bus 27, as appreciated in the art. In operation, the APM 29 is capable, via internal switching and voltage transformation, of reducing a voltage level on the DC bus 27 to a lower level suitable for charging the auxiliary battery (BAUx) 30 and/or supplying low-voltage power to one or more accessories (not shown) such as lights, displays, etc. Thus, “high-voltage” refers to voltage levels well in excess of typical 12-15V low/auxiliary voltage levels, with 400V or more being an exemplary high-voltage level in some embodiments of the battery pack 12.

In some configurations, the electrified powertrain system 10 of FIG. 1 may include an on-board charger (OBC) 32 that is selectively connectable to an offboard charging station 33 via an input/output (I/O) block 132 during a charging mode during which the battery pack 12 is recharged by an AC charging voltage (VCH) from the offboard charging station 33. The I/O block 132 is connectable to a charging port 17 on the vehicle body 22. For instance, a charging cable 35 may be connected to the charging port 17, e.g., via an SAE J1772 connection. The electrified powertrain system 10 may also be configured to selectively receive a DC charging voltage in one or more embodiments as appreciated in the art, in which case the OBC 32 would be selectively bypassed using circuitry (not shown) that is not otherwise germane to the present disclosure. The OBC 32 could operate in different modes, including a charging mode during which the OBC 32 receives the AC charging voltage (VCH) from the offboard charging station 33 to recharge the battery pack 12, and a discharging mode, represented by arrow Vx, during which the OBC 32 offloads power from the battery pack 12 to an external AC electrical load (L). In this manner, the OBC 32 may embody a bidirectional charger.

Still referring to FIG. 1, the electrified powertrain system 10 may also include an electronic control unit (ECU) 34. The ECU 34 is operable for regulating ongoing operation of the electrified powertrain system 10 via transmission of electronic control signals (arrow CCo). The ECU 34 does so in response to electronic input signals (arrow CC₁). Such input signals (arrow CC₁) may be actively communicated or passively detected in different embodiments, such that the ECU 34 is operable for determining a particular mode of operation. In response, the ECU 34 controls operation of the electrified powertrain system 10.

To that end, the ECU 34 may be equipped with one or more processors (P), e.g., logic circuits, combinational logic circuit(s), Application Specific Integrated Circuit(s) (ASIC), electronic circuit(s), central processing unit(s), semiconductor IC devices, etc., as well as input/output (I/O) circuit(s), appropriate signal conditioning and buffer circuitry, and other components such as a high-speed clock to provide the described functionality. The ECU 34 also includes an associated computer-readable storage medium, i.e., memory (M) inclusive of read only, programmable read only, random access, a hard drive, etc., whether resident, remote or a combination of both. Control routines are executed by the processor to monitor relevant inputs from sensing devices and other networked control modules (not shown), and to execute control and diagnostic routines to govern operation of the electrified powertrain system 10.

Different types of lithium-ion cells have various advantages. For example, a nickel cobalt manganese aluminum (NCMA) battery cell refers to the cathode material on the lithium ion battery. While many battery cells just use NCM materials or variations thereof due to their relatively high energy density, one advantage of the NCMA battery cell is that it raises the nickel content and replaces much of the cobalt, a relatively rare substance, with aluminum while maintaining cell longevity and without sacrificing much energy density. While NCM, NCMA and similar battery cell architectures in general have a high energy density, they require thermal management systems due to their high temperatures and potential concerns for damage. In contrast lithium-iron phosphate (LFP) battery cells have a lower energy density than the NCM-based cells. LFP cells are cheaper, however, and do not require thermal management since they do not reach the temperatures of their NCMA counterparts. LFP cells are also safer in light of their lower energy density and manageable temperatures. Generally, due to their higher energy densities, most electric vehicles (EVs) use NCM-based lithium ion batteries. For purposes of this disclosure, the term “NCM-based” shall be construed to include cells with either NCM or NCMA cathodes.

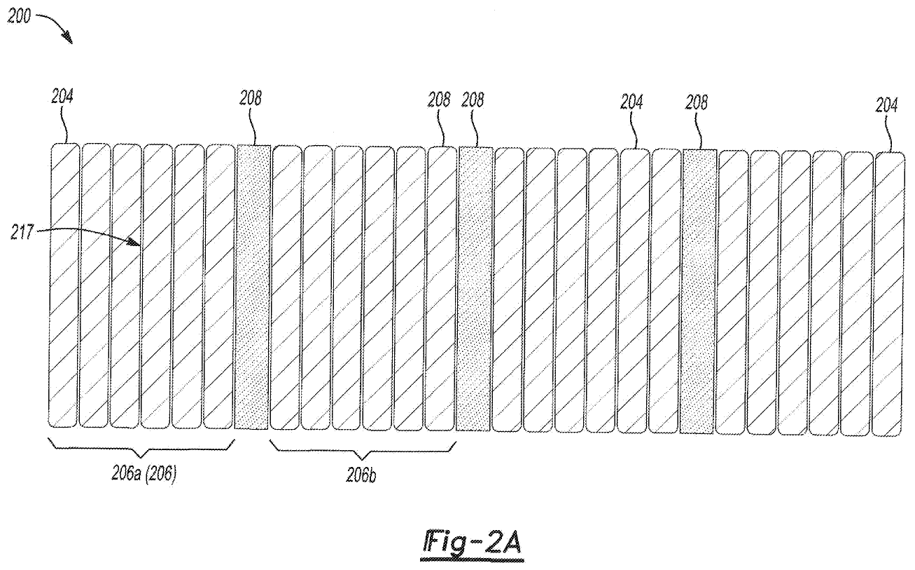

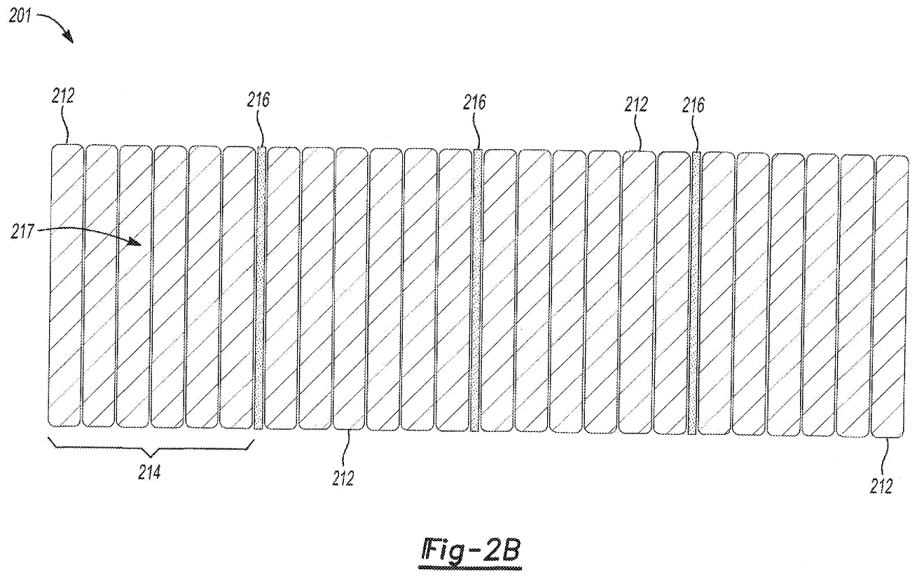

FIG. 2A is an exemplary cross-sectional front view 217 of a module 200 in a 2P12S (6:1) configuration using high energy density cells 204. For simplicity, the front view 217 of FIG. 2A omits metallic connectors or references to positive or negative electrodes. Examples of high energy density-based cells include cells using NCMA and NCM cathodes, among others. The cells 204 in module 200 are the same type. Examples of low energy density-based cells (FIG. 2B) include, for example, cells using LFP cathodes. Referring back to FIG. 2A, the reference to 2P12S means that the cells in this embodiment are connected two in parallel (2P) and twelve in series (12S) in a six cell per group ratio (6:1) to realize a 24-cell module 200. The existing module configuration shown in FIG. 2A includes six cells 204 per a single group 206. The group 206 is separated from the next succeeding group 206b by a cell barrier 208. The cell barrier 208 is generally composed of a thermally insulating material. Four groups 206 of six cells 204 each yield a total of twenty-four cells in this embodiment, with three cell barriers 208 to segregate the respective groups. The high energy density-based cells may include NCM (nickel cobalt manganese) or NCMA (nickel cobalt manganese aluminum) as the cathode material in some embodiments. The high energy density-based cells may include lithium or derivatives thereof in other embodiments. In some embodiments, the high energy density-based cells produce a module energy of 10 KWh or greater.

FIG. 2B is an exemplary front view 217 of a module 201 in a 2P12S (6:1) configuration using low energy density cells. These cells include, for example, cells using LFP (LiFEPO₄) cathode material, among others. Like FIG. 2A and for simplicity, the front view of FIG. 2B omits metallic connectors or references to positive or negative electrodes. Similar to the module 200 of FIG. 2A, the module 201 of FIG. 2B includes a total of 24 cells 212, with six cells 212 per group 214, and four groups total. One difference between the module 201 of FIG. 2B as compared to the module 200 in FIG. 2A is that module 201 includes thinner cell barriers 216. These thinner cell barriers 216 can be used due to the lower energy density of the cells in FIG. 2B. In some embodiments, the cells 212 are LFP cells—that is, they use LFP (Lithium iron Phosphate) material on the cathodes. In various embodiments, the low energy density-based cells produce a module energy of less than seven (7) kilo-Watt hours (kWh).

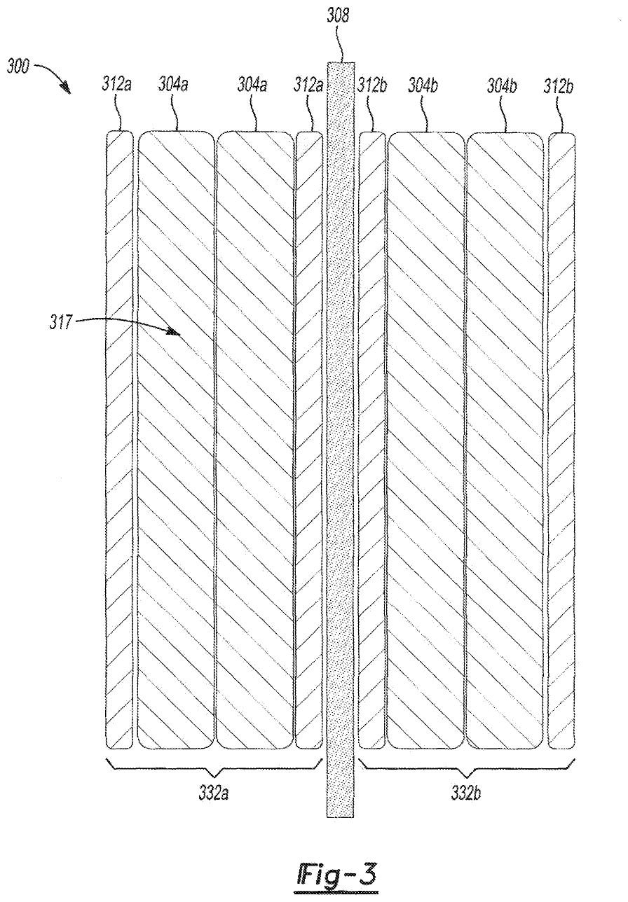

FIG. 3 is an exemplary front view of two groups of a 4:1 module 300 according to an aspect of the disclosure. The reference “4:1” indicates that four cells reside in a single group 332a or 332b. For example, in group 332a to the left of cell barrier 308, two high energy density-based cells 304a are disposed or sandwiched between a low energy density-based cell 312a on either side. In this embodiment, the high energy density-based cells are thicker than the low energy-density based cells, because the former can store and produce more energy. For convenience and simplicity, a front view 317 of the module 300 is shown. In this design, each front of a cell (e.g., cell 312a or cell 304a) may be associated with an electrode having a positive polarity (a “cathode”) or an electrode having a negative polarity (an “an anode”). The other example is the group 332b to the right of the cell barrier 308, which similarly includes two high energy density-based cells disposed between a low energy density-based cell 312b on either side.

Because in the example of FIG. 3 the high energy density-based cells are included with low energy density-based cells, the onset temperature for TRP may be made higher, without an appreciable corresponding sacrifice in the energy storage and discharge capability of the module. The thickness of the cell barrier 308 is generally a function of a maximum temperature of the cells during thermal propagation. For example, in some embodiments, high energy density-based cells (when produced in a single module) can reach up to 1000 degrees Celsius during TRP. With the example hybrid module assembly shown in FIG. 3, a higher energy density can be achieved using a thinner, and consequently lower cost cell barrier 308.

Moreover, while FIG. 3 shows a two-group module 300 for simplicity, the module 300 itself can in various embodiments be made more compactly, meaning that more such modules 300 can be stored in a given region. The use of the high and low energy density-based cells 312a, 304a, 312b, and 304b in groups 332a and 332b has the further advantage that the TRP onset temperature for low energy density cells 312a and 312b is also higher. Thus, the relative thickness of the cell barrier 308 can be reduced based on an overall higher temperature for TRP. Advantage is two-fold with reduced peak temperature of thermal runaway cells and higher onset temperature required for an adjacent group of cells.

Aspects of the present disclosure are directed to battery cells that use a combination of low and high energy densities to reduce cell barrier thickness and provide increased thermal stability.

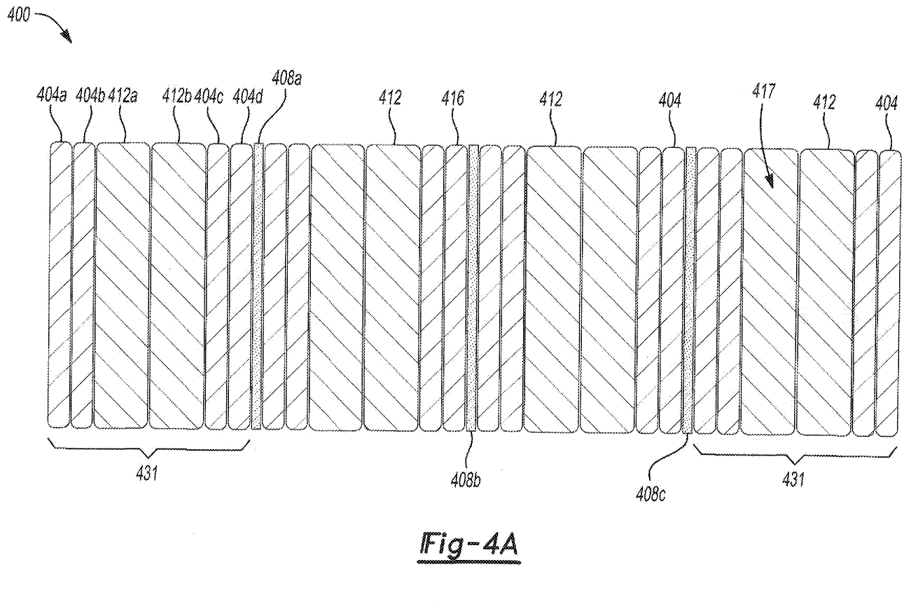

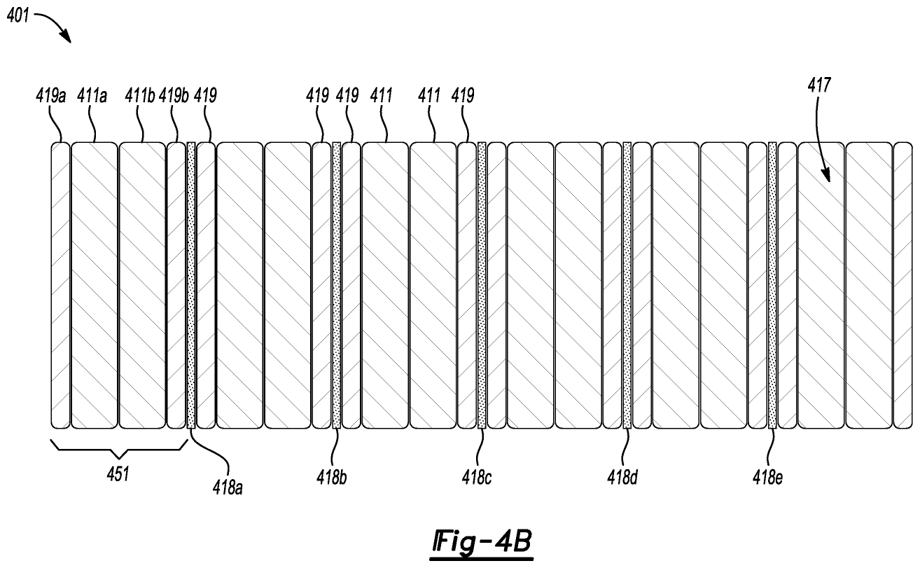

FIG. 4A is an exemplary front view 417 of a module 400 in a 2P12S (6:1) configuration which combines cells for increased thermal stability according to example embodiments. The module 400 is shown with a front 417 of the module exposed, as noted. The module 400 has six cells per group (hence the 6:1 designation) and as will be shown below, is connected in a two-parallel and twelve series (2P12S) configuration.

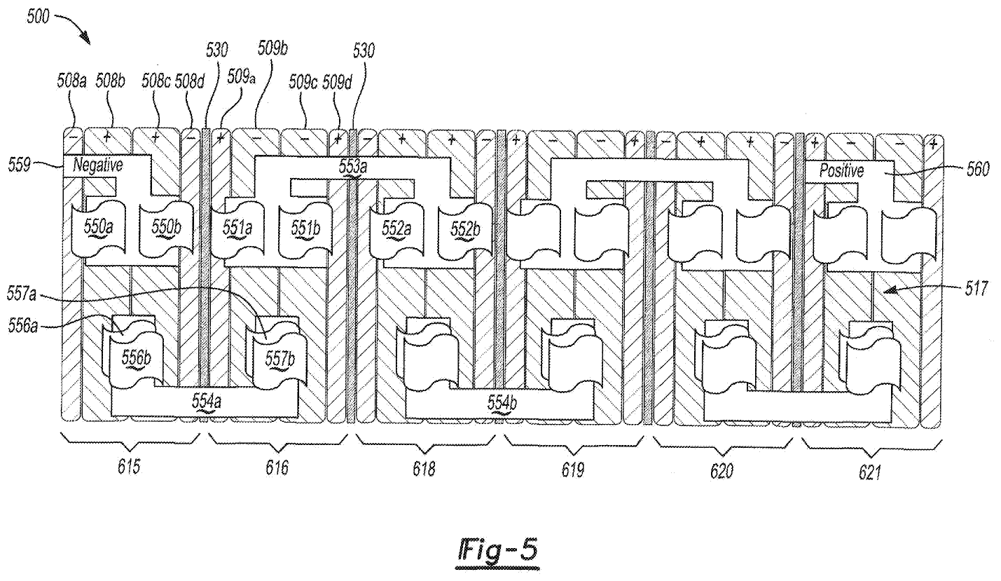

Referring still to FIG. 4A, the module 400 has four groups 431, each group being separated by cell barriers 408a, 408b, and 408c. In this embodiment, each of the groups 431 have an identical cell configuration. Referring to the leftmost group 431, two high energy density-based cells, 412a and 412b, are disposed on each side between two low energy density-based cells 404a and 404b on the left, and two low energy density-based cells 404c and 404d on the right. Immediately to the right of the rightmost cell 404d in the leftmost group 431 is a cell barrier 408a having a reduced thickness relative to that of a cell barrier when high energy density-based cells are used, as in FIG. 2A, for example. For purposes of this disclosure, high energy density-based cells 412 are the NCM family of cathode active materials (e.g., LiₓNi_{1-y-z}Co_{y}Mn_{z}O₂), NCA (Li₁Ni_{1-y-z}Co_{y}Al_{z}O₂), lithium nickel oxide (LNO or LilNi1O₂), Lithium Nickel Manganese Cobalt Oxide (NMC) and Lithium Cobalt Oxide (LCO). Low energy density-based cells 404 are lithium iron phosphate (LFP) and lithium titanate (LTO). Other cell types, both high and low energy based and having comparable ranges of output energy for a given mass, can also be used. The cell barriers 408a-c may include aerogel or another binder material. The cell barriers 408a-c may act both as a thermal and electrical insulator. As described further below with reference to FIGS. 5-8, the front 417 of each cell as viewed in FIG. 4A includes an electrode having a positive or negative polarity. If, for example, the front 417 of cell 404a has a positive polarity (a cathode), then the back (obscured from view) of cell 404a has a negative polarity (an anode), and vice versa for each cell 404 and 412.

Inserting the high energy density-based cells 412a-b between the low energy density-based cells (e.g., cells 404a and 404b on the left and cells 404c and 404d on the right for group 431) reduces the cost of the TRP mitigation solution without dramatically reducing the energy density of the module 400, and hence maintaining almost the same mileage range in an EV relative to the case where purely high energy density-based cells are used.

FIG. 4B is an exemplary front view 417 of a module 401 in a 2P12S (4:1) configuration which combines cells for increased thermal stability according to example embodiments. Like in FIG. 4A, the module 401 shows a front view 417. Module 401 has four cells per group (hence the 4:1 configuration) and is assembled with two in parallel and twelve in series, as described further below. It will be appreciated by those skilled in the art upon review of this disclosure that different module configurations, cell numbers, group numbers, and other criteria may vary based on the needs and objectives of the module without departing from the spirit or scope of the disclosure.

The leftmost exemplary group 451 in the example of FIG. 4B includes two high energy density-based cells 411a and 411b disposed between a low energy density-based cell 419a on the left side and a low energy density-based cell 419b on the right side. This pattern repeats for each of the groups 451, with each group 451 including two high energy density-based cells sandwiched between a single low energy density-based cell 419 on either side. A total of five cell barriers 418a-e are used in this example to electrically and thermally insulate the respective groups 451. Like in FIG. 4A, the cell barriers 418a-e can be made thinner, reducing cost and increasing physical capacity of the module 401. The high and low energy density-based cells 411 and 419, respectively, and the cell barriers 418a-e can be made from the same materials as described above, for example, with reference to FIG. 4A.

The following table illustrates the values of certain parameters for the existing modules 200 and 201 using NCMA and LFP materials for the high and low energy density-based cells, respectively, and for the exemplary embodiments of modules 400 and 401 in FIGS. 4A and 41, respectively. In this example, for modules 400 and 401, the high energy density-based cells have NCMA-based cathodes, and the low-energy density-based cells have LFP-based cathodes. Each module 200, 201, 400 and 401 has a 2P12S configuration. Modules except module 401 (FIG. 4B) include a 6:1 cell-to-group ratio. Module 401 uses a 4:1 cell-to-group ratio, as demonstrated in FIG. 4B. It should be understood that the values in the following table are by way of example and are subject to change based on the module configuration. It will also be appreciated that each of the modules may include a housing in which the consecutive groups are seated. The housing may include end plates at the far right and left of the module. The housing and end plates are omitted for simplicity and to avoid unduly obscuring the concepts disclosed herein. The width of the module in the table below is measured horizontally between and including the far left and far right cells. It will also be appreciated that in operation, some of the materials may be compressible or may expand within the module package.

| | Module 200 | | Module 400 | Module 401 |
|---|---|---|---|---|
| | FIG. 2A | Module 201 | FIG. 4A | FIG. 4B |
| | MCP1 | FIG. 2B | 2P12S | 2P12S |
| | 2P12S | 2P12S | (6:1) | (4:1) |
| | (6:1) | (6:1) | (NCMA + | (NCMA + |
| | (NCMA) | (LFP) | LFP) | LFP) |
| Module width | 257.2 | 257.2 | 257.2 | 257.2 |
| between end | | | | |
| plates in milli- | | | | |
| meters (mm) | | | | |
| Cell barrier | 26.25 | 8.0 | 8.0 | 12.0 |
| thickness (e.g., | | | | |
| an aerogel or | | | | |
| another insulat- | | | | |
| ing material) | | | | |
| (mm) | | | | |
| Foam (or other | 15.0 | 15.0 | 15.0 | 15.0 |
| compressible | | | | |
| material) thick- | | | | |
| ness (mm) | | | | |
| Thickness of | 9 mm | 9.8 mm | 15.3 mm | 12.2 mm |
| Cells in each | (6 NCMA | (6 LFP | (2 NCMA | (2 NCMA |
| group (mm) | cells) | cells) | cells) 7 | cells) 7 |
| | | | mm (4 LFP | mm (4 LFP |
| | | | cells) | cells) |
| Module Energy | 10.8 | 6.7 | 9.3 | 9.7 |
| in Kilowatt- | | | | |
| hours (KWh) | | | | |

As is evident from the table, the width of modules 400 and 401 can be kept the same as, or substantially equivalent to, the width of modules 200 and 201, although in various embodiments different widths are possible. In the high energy density-based module 200 of FIG. 2A, the NCMA cell barrier thickness is 26.25 mm, compared to the 8 mm thickness of the LFP module 201 in FIG. 2B. Thus, the high energy density-based module in this example is over three times as thick as the corresponding low energy density-based module. However, for the combined module 400 in FIG. 4A, the cell barrier thickness is the same as the LFP module 201 (FIG. 2B3). For the module 401 in FIG. 4B3, the cell barrier thickness is about 12 mm, which is still less than half the width of the high energy density-based module 200 (FIG. 2A).

Also noteworthy in the table is the total module energy. The example high energy density-based module 200 (FIG. 2A) can store and output about 10.8 Kilowatt-hours (KWh), while the example low energy density-based module 201 (FIG. 2B3) can store and output about 6.7 KWh. By contrast, the combined-cell module 400 can store and output about 9.3 KWh, while the combined-cell module 401 can store and output about 9.7 KWh. From this example it is evident that the total module energy is close to the original energy of the high energy density-based module using NCMA. Advantageously, the cell barrier for modules 400 and 401 can be made substantially thinner than the high energy density-based module 200. For the module 400 (FIG. 4A), the cell barrier thickness can be made about the same as the low energy density-based module 201. The cell barrier thickness for module 401 is about 4 mm larger than that of the low energy density-based module 201 and is less than half the thickness of the high energy density-based module.

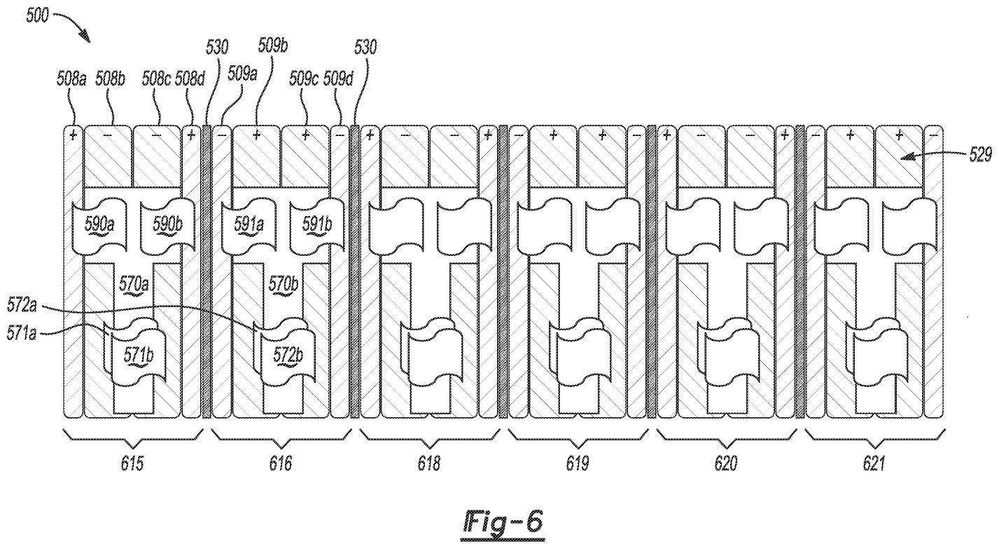

In another aspect of the disclosure, a unique asymmetric tab and bus bar configuration is disclosed. FIG. 5 is an exemplary front view 517 of an example module 500 in a 2P12S (4:1) configuration with bus bars and tabs in accordance with an aspect of the disclosure. FIG. 6 is an exemplary back view 529 of the example module 500 of FIG. 5 with additional bus bars and tabs in accordance with an aspect of the disclosure. While in some configurations the front and back views may alternatively be referred to as two different side views, for simplicity the view of FIG. 5 is referred to the front 517 of the module and the view of FIG. 6 is referred to the back 529 of the module 500. It is assumed for purposes of these figures that group 615 is on the leftmost side of the module 500 in either view from the front 517 or the back 529. Each of the six groups 615, 616, 618, 619, 620, and 621 include four cells. Referring to the front 517 of the module in FIG. 5, the leftmost cell 615 includes two high energy density-based cells 508b and 508c disposed between a low energy density-based cell 508a on the left and a low energy density-based cell 508d on the right. The remaining groups 616, 618, 619, 620 and 621 have the same configuration.

It can be seen with reference to module 500 that the front 517 of cell 508a has a negative electrode and is thus an anode. Thus, the back 529 of the same cell 508a as shown in FIG. 6 has a positive electrode or cathode. The front 517 of cells 508b and 508c are positive and hence show cathodes, meaning that the back 529 of the same cells 508b and 508c are negative (anodes). The front 517 of cell 508d is an anode, and so the back 529 of cell 508d is a cathode. With brief reference to FIG. 6, the back 529 of group 615 includes bus bar 570a, which is coupled to the cathode portion of cells 508a and 508d.

Referring to FIG. 5, battery module 500 includes a plurality of cell barriers 530 (also visible in FIG. 6) which separate the groups 615, 616, 618 and 619. The front 517 of group 615 includes a bus bar 559 corresponding to an anode of the battery module 500. The bus bar 559 may protrude through the housing or packaging (not shown) of the module 500 for additionally connecting to other modules. Bus bar 559 is coupled to the anodes of low energy density-based cells 508a and 508d via tabs 550a and 550b, respectively. The bus bar 559 is electrically coupled to cells 508a and 508d but is electrically isolated from cells 508b and 508c using existing techniques. The bus bar and tabs may be made of copper or aluminum. In one embodiment, for example, the tab and bus bars may be composed of copper where they contact the anode (negative electrode), and aluminum where they contact the cathode (positive electrode).

In the embodiment of FIGS. 5 and 6, the tabs associated with the high energy density-based cells are welded near the top of the bus bar, while the tabs associated with the low energy density-based cells are welded near the bottom of the bus bar. For example, referring to the bus bar 553a of module 500 in FIG. 5, the tabs 551a, 551b, 552a, and 552b are welded near the bottom the bus bar 553a. Advantageously, using the bus bar and tabs as disclosed, the 2P12S configuration can be achieved even when the high energy density-based cells (e.g., 508b and 508c) are sandwiched between the low energy density-based cells (e.g., 508a and 508d). For example, the tabs 550a and 550b can be coupled to two low energy density-based cells 508a and 508d, while the tabs 556a and 556b can be coupled to two high energy density-based cells 508b and 508c to achieve the two cells in parallel and 12 cells in series (2P12S) configuration despite that two different cell types are used.

To illustrate this principle, an exemplary current flow can be shown to traverse the different electrodes of the battery using two cells in parallel. With initial reference to group 615 of FIG. 5, current can flow into the anode defined by bus bar 559, tabs 550a-b, and the anodes of low energy density-based cells 508a and 508d. Still referring to FIG. 5, the lower portion of cells 508b and 508c are respectively coupled to tabs 556a and 556b. Tabs 556a and 556b are in turn coupled via bus bar 554a from group 615 to adjacent group 616 and in particular to high energy density-based cells 509b and 509c via the bus bar 554a and respective tabs 557a and 557b. Another identical bus bar 554b couples the high energy density-based cells of adjacent groups 618 and 619 in a similar manner.

Referring now to FIG. 6, current from the module flows from the cathodes of the same cells 508a and 508b, through tabs 590a and 590b, through bus bar 570a and via tabs 571a-b into the anodes of high energy density-based cells 508b-c. Referring back to FIG. 5, current flows from the cathodes of high energy density-based cells 508b-c via tabs 556a-b into the parallel cathodes in the adjacent group 616, i.e., high energy density-based cells 509b-c. In FIG. 6, current flows from the anodes of high energy density-based cells 509b-c through tabs 572a-b and bus bar 570b, and into the anodes of low energy density-based cells 509a and 509d via tabs 591a-b.

The process continues at FIG. 5, where current flows from the cathodes of low energy density-based cells 509a and 509d, and into bus bar 553a via tabs 551a-b, where the current is carried into the next adjacent group 618. Current flows into the anodes of the two low energy density-based cells in group 618 via tabs 552a-b, and the process continues as current flows through two parallel cells through the remaining adjacent groups 619, 620 and 621 including the various high and low energy density-based cells, tabs and bus bars until it reaches the positive electrode 560.

The disclosed tab and bus bar configuration is such that in one embodiment, low energy density-based cells can flow through tabs disposed on the upper portion of the respective cells, while high energy density-based cells can flow through tabs disposed on the lower portion of the respective cells.

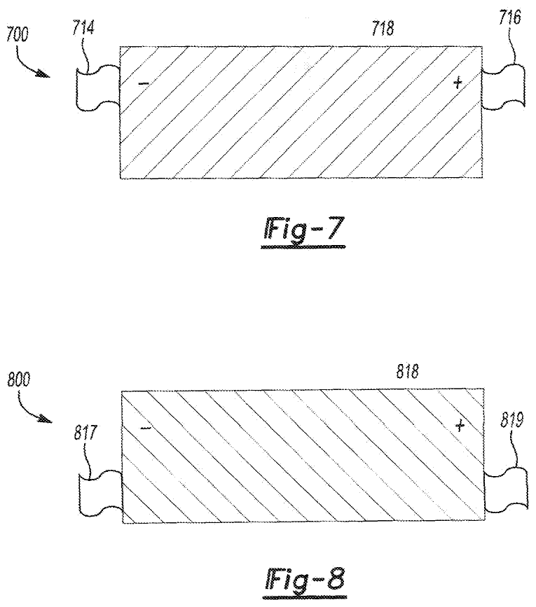

FIG. 7 is an exemplary side view of a low energy density-based battery cell 700 with the tabs arranged near the top of the cell. For example, the tab 714 corresponding to the anode on a first side of the cell 700 is arranged near the top of the cell. The tab 716 corresponding to the cathode on a second side of the cell 700 is also arranged near the top of the cell. FIG. 8 is an exemplary side view of a high energy density-based battery cell 800 with the tabs arranged near the bottom of the cell. The tab 817 corresponding to the anode of the high energy density-based cell 800, and the tab 819 corresponding to the cathode of the same cell 800, are both arranged near the bottom of the cell. This configuration advantageously disperses the tabs so that there is ample room on the module for the multiple tabs needed to implement the 2P12S configuration. Other configurations may be contemplated using the principles discussed above and fall within the spirit and scope of the disclosure.

The detailed description and the drawings or figures are supportive and descriptive of the present teachings, but the scope of the present teachings is defined solely by the claims. While some of the best modes and other embodiments for carrying out the present teachings have been described in detail, various alternative designs and embodiments exist for practicing the present teachings defined in the appended claims. Moreover, this disclosure expressly includes combinations and sub-combinations of the elements and features presented above and below.

What is claimed is:

1. A battery module comprising:
a plurality of groups, each group comprising one or more high energy density-based cells disposed on each side between one or more low energy density-based cells; and
a cell barrier disposed between each of the plurality of groups, a thickness of the cell barrier being reduced based at least in part on an increased onset temperature of a thermal runaway propagation (TRP) condition occurring in one or more of the plurality of groups.

2. The module of claim 1, wherein:
each group comprises at least four cells;
the one or more high energy density-based cells comprise at least two adjacent cells; and
the one or more low energy density-based cells comprise two cells between which the two adjacent cells are disposed.

3. The module of claim 2, further comprising:
a first bus bar on a front of the module and extending across an upper part of a first set of two adjacent groups, the first bus bar coupled via two first tabs to two respective low energy density-based cells in a first group of the two adjacent groups and via two second tabs to two respective low energy density-based cells in a second group of the two adjacent groups.

4. The module of claim 3, further comprising:
a second bus bar arranged on the front of the module and extending across a lower part of a second set of two adjacent groups including one of the two adjacent groups from the first set, the second bus bar coupled via two third tabs to two respective high energy density-based cells in the one group from the first set and via two fourth tabs to two respective high energy density-based cells in a remaining group from the second set of two adjacent groups.

5. The module of claim 4, further comprising:
a plurality of third bus bars on a back of the module, each bus bar extending across an upper portion and a lower portion of each respective one of at least two adjacent groups, wherein each of the plurality of third bus bars is coupled to two low energy density-based cells via two respective fifth tabs across the upper portion and to two high energy-density-based cells via two respective sixth tabs across the lower portion.

6. The module of claim 1, wherein the high energy density-based cell comprises one of a nickel cobalt manganese (NCM) cell or a nickel cobalt manganese aluminum (NCMA) cell.

7. The module of claim 1, wherein a module configuration is a 2P12S configuration including four groups per cell.

8. The module of claim 1, wherein a module configuration is a 2P12S configuration including six groups per cell.

9. The module of claim 1, wherein a module energy output is between 6 and 12 Kilowatt Hours (kWh).

10. A battery module comprising:
a plurality of groups comprising at least two high energy density-based cells disposed on each side between one low energy density-based cell;
a cell barrier disposed between each of the plurality of groups, a thickness of the cell barrier being reduced based at least in part on an increased onset temperature of a thermal runaway propagation (TRP) condition occurring in one or more of the plurality of groups; and
a first bus bar on a front of the module and extending across an upper part of a first of two adjacent groups, the first bus bar coupled via two first tabs to two respective low energy density-based cells in a first group of the two adjacent groups and via two second tabs to two respective low energy density-based cells in a second group of the two adjacent groups.

11. The module of claim 10, further comprising:
a second bus bar on the front of the module and extending across a lower part of a second group of two adjacent groups including one group from the first group of two adjacent groups, the second bus bar coupled via two third tabs to two respective high energy density-based cells in the one group and via two fourth tabs to two respective high energy density-based cells in a remaining one of the second of two adjacent group.

12. The module of claim 11, further comprising:
a plurality of third bus bars on a back of the module, each third bus bar extending across an upper portion and a lower portion of each respective one of at least two adjacent groups, wherein each of the plurality of third bus bars is coupled to two low energy density-based cells via two respective fifth tabs across the upper portion and to two high energy-density-based cells via two respective sixth tabs across the lower portion.

13. The module of claim 11, wherein the high energy density-based cell comprises one of a nickel cobalt manganese (NCM) cell or a nickel cobalt manganese aluminum (NCMA) cell.

14. The module of claim 11, wherein a module configuration is a 2P12S configuration including four groups per cell.

15. The module of claim 11, wherein a module configuration is a 2P12S configuration including six groups per cell.

16. The module of claim 11, wherein a module energy output is between 6 and 12 Kilowatt Hours (kWh).

17. A battery module comprising:
a plurality of groups, each group comprising a plurality of high energy density-based cells disposed on each side between at least one low energy density-based cell; and
a cell barrier arranged between each of the plurality of groups, a thickness of the cell barrier being reduced based at least in part on an increased onset temperature of a thermal runaway propagation (TRP) condition occurring in one or more of the plurality of groups.

18. The module of claim 17, wherein the high energy density-based cell comprises one of a nickel cobalt manganese (NCM) cell or a nickel cobalt manganese aluminum (NCMA) cell.

19. The module of claim 17, wherein a module configuration is a 2P12S configuration including four groups per cell.

20. The module of claim 17, wherein a module configuration is a 2P12S configuration including six groups per cell.
